(19) United States
(12) Patent Application Publication
(10) Pub. No.: US 2026/0201794 A1
(43) Pub. Date: Jul. 16, 2026

(54) PERMANENT DOWNHOLE MONITORING ASSURANCE SURVEILLANCE SYSTEM

(71) Applicant: SAUDI ARABIAN OIL COMPANY, Dhahran (SA)

(72) Inventors: Mohammed Elmetwally Gomaa, Ras Tanura (SA); Mohamed Nabil Noui-Mehidi, Dhahran (SA); Karam Sami Yateem, Ras Tanura (SA); Ahmad Ibrahim Mubarak, Saihat (SA)

(73) Assignee: SAUDI ARABIAN OIL COMPANY, Dhahran (SA)

(21) Appl. No.: 19/016,166

(22) Filed: Jan. 10, 2025

(51) Int. Cl. E21B 47/06; G01L 27/00; G06Q 10/20

(52) U.S. Cl. CPC E21B 47/06; G01L 27/007; G06Q 10/20; E21B 2200/20

(57) ABSTRACT

Systems and methods are disclosed. The methods may include obtaining sensor data from a plurality of sensors of a well comprising a first downhole pressure sensor, determining, using a first model of a data validation tool, whether the first downhole pressure sensor is faulty based on the sensor data; and upon so determining, using a second model of the data validation tool known as a downhole pressure estimation tool (DPET), predicting a predicted pressure for the first downhole pressure sensor based on a subset of the sensor data, determining an operating state of the well based on the predicted pressure; and transmitting a recommended action based on the operating state. The methods may also include predicting, using a predictive equipment failure tool, a predicted future sensor failure for at least one sensor, and transmitting, using a data verification tool, a recommended action based on the predicted future sensor failure.

### BACKGROUND

Downhole pressure and temperature monitoring are necessary to optimize both production and injection strategies when producing a hydrocarbon field. The monitoring may be done by an expert via real-time pressure surveillance. However, failure prediction by an expert is very time intensive, thus leading to higher operating costs. Furthermore, an expert introduces subjectivity into the process.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method, the method including obtaining sensor data from a plurality of sensors disposed in a well, using a data validation tool determining, using a first model of the data validation tool, a presence of a faulty sensor in the plurality of sensors based, at least in part, on the sensor data, determining, with a second model of the data validation tool, a predicted value of the faulty sensor based, at least in part, on a subset of the sensor data, and determining an operating state of the well based, at least in part, on the predicted value. The method further includes transmitting, using a data verification tool, a recommended action based on the operating state.

In one aspect, embodiments disclosed herein relate to a method, the method including obtaining sensor data from a plurality of sensors disposed in a well, predicting, using a predictive equipment failure tool, a predicted future sensor failure for at least one sensor of the plurality of sensors based, at least in part, on the sensor data, and transmitting, using a data verification tool, a recommended action based on the predicted future sensor failure

In one aspect, embodiments disclosed herein relate to a system. The system includes a plurality of sensors disposed in a well, configured to obtain sensor data, a data validation tool, and a data verification tool. The data validation tool is configured to determine, using a first model of the data validation tool, a presence of a faulty sensor in the plurality of sensors based, at least in part, on the sensor data, determine, with a second model of the data validation tool, a predicted value of the faulty sensor based, at least in part, on a subset of the sensor data, and determine an operating state of the well based, at least in part, on the predicted value. The data verification tool, is configured to transmit a recommended action based on the operating state.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIG. 1 shows a borehole in accordance with one or more embodiments.

FIG. 2 shows a downhole pressure reading in accordance with one or more embodiments.

FIG. 3 shows a downhole pressure reading in accordance with one or more embodiments.

FIG. 4A shows a spectrogram in accordance with one or more embodiments.

FIG. 4B shows a spectrogram in accordance with one or more embodiments.

FIG. 5 shows a neural network in accordance with one or more embodiments.

FIG. 6 shows a workflow in accordance with one or more embodiments.

FIG. 7 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

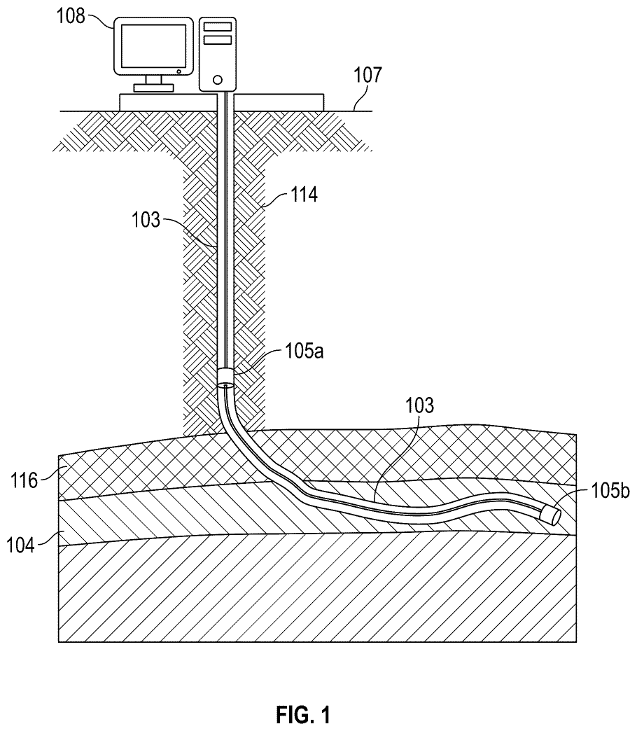

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a machine learning model” includes reference to one or more of such machine learning models.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In one aspect, embodiments disclosed herein relate to a permanent downhole monitoring assurance surveillance system (PDMASS): an integrated automated system to monitor, analyze, and predict failure of equipment both on the surface and downhole in real time with no manual intervention. The PDMASS obtains physical measurements of downhole systems and characteristics and is designed to identify potential failures in advance. In addition, it includes the functionality to estimate or predict the value of one variable from the measured values of other variables, e.g., fluid viscosity may be predicted from temperature and density. This functionality may be used when the sensor measuring the value of one variable becomes faulty or is suspected to be faulty, and the functionality may be used as an interim solution to provide the value of the predicted variable until the corresponding sensor may be repaired or replaced. In particular, the PDMASS may include as an element a Downhole Pressure Estimation Tool (DPET) that may be utilized in the case where one out of two or more downhole pressure gauges fails to ensure reliable downhole pressure readings. This process may be done intermittently and inadequately on an ad hoc basis by a human expert with results that may vary based on the expert's experience. Embodiments of the present disclosure may form an improved solution to the problem and a more consistent and complete replacement for existing processes.

The PDMASS (108) may operate within an existing borehole (103). As shown in FIG. 1, a borehole (103) may be drilled from the surface (107) of the earth to a subterranean region of interest. The borehole (103) may traverse a plurality of overburden (114) layers and one or more cap-rock (116) layers to a hydrocarbon reservoir (104) within the subterranean region of interest. The borehole (103) may be a curved borehole, or a straight borehole. All or part of the borehole (103) may be vertical, and some boreholes (103) may be deviated or have horizontal sections.

The PDMASS (108) may be located on the surface (107) and be in communication with sensors, such as sensors (105a, 105b), located within the borehole (103). The sensors provide the PDMASS (108) and its operator with physical measurements and other information related to the subsurface—particularly, the physical state of the borehole (103) at depth. Each sensor may be positioned or configured to measure a desired physical stimulus. The physical measurement may be, without limitation, the following: gauge pressure data, gauge temperature data, upstream wellhead pressure data, upstream wellhead temperature data, downstream wellhead pressure data, reservoir pressure data, choke valve position, ESP frequency data, ESP motor current data, friction loss data, gravity data, different Zone water content (WC) data, vertical distance data, bubble pressure data, static oil gradient data, input voltage to surface panel data, current data, and drilling depth per gauge data. The sensors may be gauges. In some embodiments, there may be an upper gauge (105a) and a lower gauge (105b). In some embodiments, the sensors may be located in the borehole (103). In other embodiments, the sensors are located at the wellhead or on the surface (107).

The sensors may communicate with the PDMASS (108) through various mechanisms. In one embodiment, the sensors may be permanently installed in the borehole (103) and connected to the surface (107) with electrical cables. Communication between the sensors and the PDMASS (108) may also be achieved through other mechanisms, such as mud pulse telemetry, electromagnetic, or acoustic waves. The communication methods listed here do not limit the invention, and other methods of communication between the PDMASS (108) and the sensors may be used.

The optimization of production and injection strategies in a borehole (103) requires real-time pressure surveillance. Consequently, real-time downhole surveillance is a daily part of production engineering operations. Gauges may be used to measure pressure within a borehole (103). PDMASS (108), through monitoring gauges or other sensors, offers the ability to minimize operating costs by reducing the wireline jobs that are typically used to install, replace, or repair sensors. PDMASS (108) also aims to detect casing leaks within the borehole (103).

In accordance with one or more embodiments, a method for utilizing the PDMASS (108) supports the evaluation and validation of downhole readings in real time on a single unified platform with no intervention. In addition, embodiments of the method present a backup plan to provide reliable results in case one gauge among many is defective. Furthermore, embodiments of the method diagnose data for potential equipment failure by analyzing waveforms and the frequency spectrum of the energy in various datasets and utilizing a wavelet analyzer of the waveform of raw data to identify the time variations to detect disturbances in the performance of the gauge. Moreover, embodiments of the method provide a recommended action in both the short term and the long term.

The PDMASS (108) consists of four main components: a Data Validation Tool; a Data Verification Tool; a Predictive Equipment Failure Tool; and an Action Points Alarm System. Each component is examined in detail below.

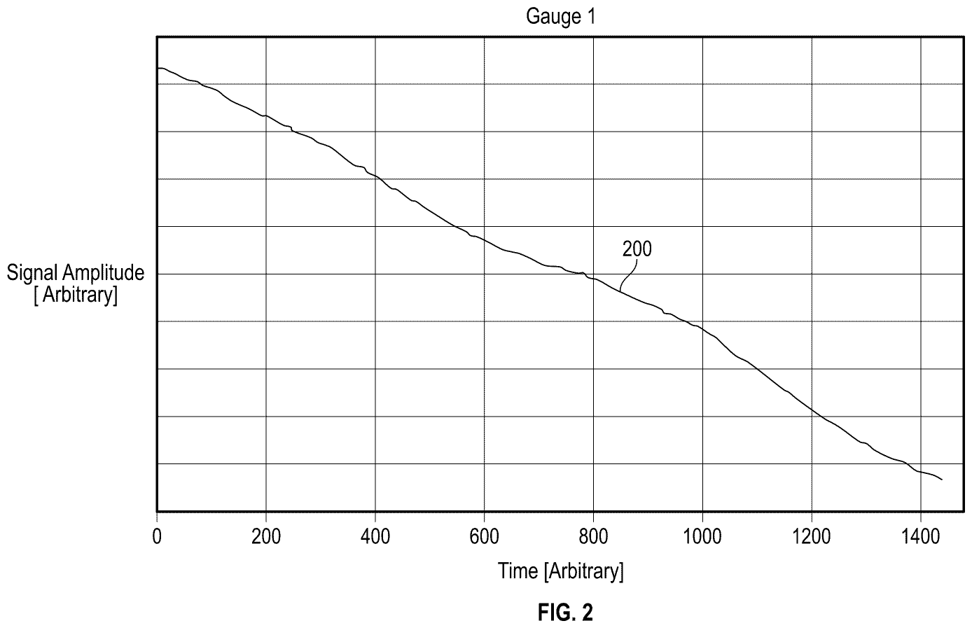

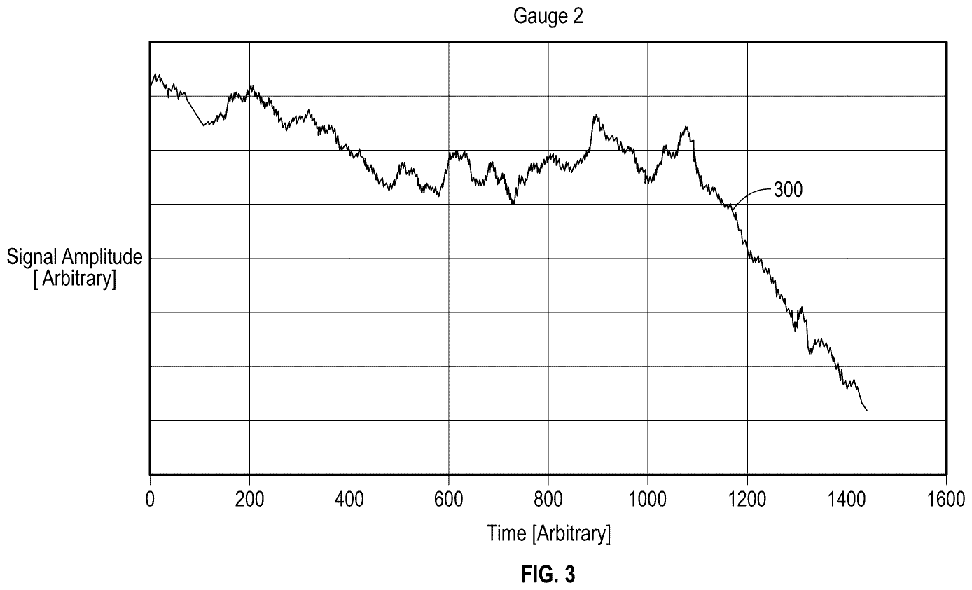

The Data Validation Tool aims to detect failures in sensors. In more detail, in some embodiments, the Data Validation Tool may compare downhole pressure, temperature, or other readings from gauges located at different depths with historical data. In some embodiments, there may be one sensor; in other embodiments there may be two or more. In the case of two sensors, they may be a lower gauge (105b) and an upper gauge (105a). In FIGS. 2 and 3, gauge readings from the upper gauge (105a) and the lower gauge (105b) are measured simultaneously and compared by the Data Validation Tool. FIG. 2 shows the upper pressure signal (200) of the upper pressure gauge (105a), indicated by the line as a function of time. The value of the pressure reading is indicated on the vertical axis and may be measured in Pascals, pounds per square inch, or other suitable units. The time is indicated on the horizontal axis and may use any convenient unit. For example, for a well in steady production a plot such as FIG. 2 may show a period of several days, weeks, or months. In FIG. 2, the upper pressure signal (200) decreases steadily while in FIG. 3, which shows the reading from the lower pressure gauge (105b), the second pressure signal (300) exhibits fluctuations in the signal outputs that are not expected. These latter fluctuations may be indicative of gauge failure.

The two gauges readings shown in FIGS. 2 and 3 are taken simultaneously at an upper and lower location in the borehole (103) and each gauge measures the same physical quantity. However, in other embodiments, the sequence of data collection and the number of gauges may differ. For example, a single gauge may be measured at different times. In this case, sudden changes in the behavior of a single gauge may indicate failure of the gauge. The method is not limited to one or two gauges. Three or more gauges may be monitored at the same time or at different time intervals. In some embodiments, the gauges may measure the same physical quantity, such as, without limitation, pressure or temperature, but in other embodiments the gauges may measure different physical quantities, for example, one gauge may measure flow-rate while another gauge measures pressure.

The Data Validation Tool includes within it the DPET. The DPET may be utilized in cases where the Data Validation Tool of the PDMASS (108) shows an indication of hardware failure, e.g., a gauge ceases to function correctly. The data collected by DPET may include, but is not limited to, pressures and temperatures downhole, choke opening values, as well as voltage, current, measurements of oil, gas, and water flowrates, upstream wellhead pressure, upstream wellhead temperature, downstream wellhead pressure, reservoir pressure, choke valve position, ESP frequency, ESP motor current, friction loss, gravity, different Zone WC, vertical distance, drilling depth for each gauge, rates, bubble pressure, and static oil gradient. The DPET may use one or more ML techniques to estimate downhole pressure from these alternative data types. For example, a trained ML system may provide a mapping between downhole temperature, bubble pressure, and friction loss measurements to estimate downhole pressure. This mapping may be learned with historical data pairs of the input and output to the ML method through a training process. The historical data pairs of input and output come from data previously measured in real time by the same sensors, or data measured by similar sensors at other locations and times. When new values of one or more of these alternative data types are obtained, the ML methods may predict the downhole pressure from those values.

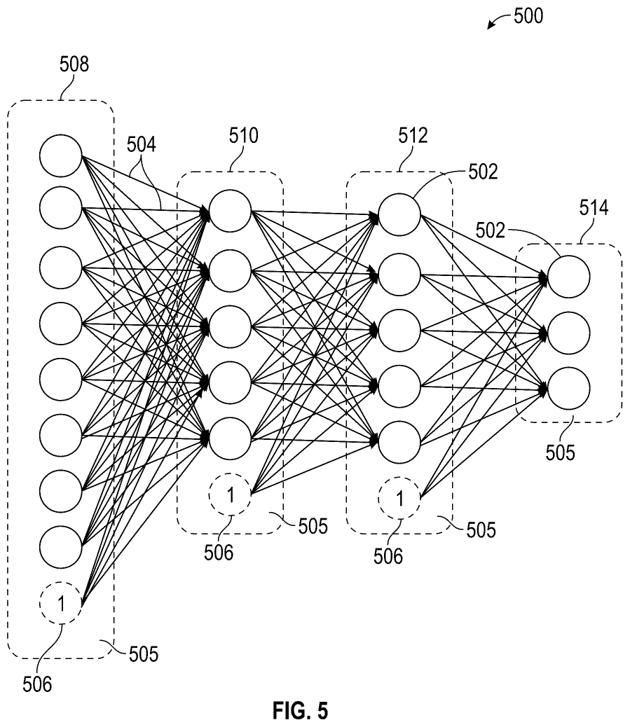

The Data Validation Tool user may choose which ML method is best for a particular subsurface field. This ML method may be designated a “first ML method”. For example, a deep learning network may be used to make a binary categorization of the state of a gauge (e.g., healthy versus failing). In some embodiments a neural network, such as the neural network (500) depicted in FIG. 5, may be used. However, in other embodiments random forests, generalized linear models, and Bayesian regression methods may be used. Further, multiple different types of ML methods may be combined to form the ML network for detecting equipment failure. Similarly, multiple different types of ML methods may be combined by the DPET to determine a downhole pressure.

For each ML model, once selected the ML model may be trained using a training set that may include observed and/or modelling data. The training methods used to train the ML model may include such as, without limitation, early stopping, adaptive or scheduled learning rates, and cross-validation, individually or in combination. The ML model may use pre-defined input parameters including a functional status for the PDHMS and determine a validation assessment by comparing the current data to the historical data.

In some embodiments, the machine learning model may be trained once, for example, using data acquired in a time period after installation of the sensor and during early production. In other embodiments, the machine learning model may be continuously or periodically retrained during the productive life of the well. In either of these embodiments, a trained machine learning model as a consequence ready for use upon the failure of one or more sensors. In still further embodiments, while the historical data for each sensor is stored the machine learning model may not be trained until a sensor failure is detected or suspected. Upon determining or suspecting the presence of the faulty sensor training the machine learning model may obtain the historical sensor data for the plurality of sensors disposed in a well from storage. The historical sensor data relates to a time-period prior to determination or suspicion of the presence of the faulty sensor. At this point a subset of sensors currently functioning normally within specification, i.e., with a current positive health status, may be selected and a historical subset from the data for subset of sensors with the current positive health status may be obtained from the historical data. In other words, the subset of sensors may be selected such that the subset of sensors excludes the faulty sensors. The machine learning model may then be training using the historical subset where the machine learning model is configured to receive, as input, current data from the subset of sensors with positive health status and return, as output, the predicted value for the faulty sensor.

In contrast to the Data Validation Tool that determines whether the data recorded is valid, the Data Verification Tool functions to discover why, if the data is not valid, invalid data is being recorded. The Data Verification Tool may monitor sensors for example through a cable that may form a permanent or semi-permanent link from the sensor to the surface of the earth. In other embodiments, the sensor may be monitored using a temporarily deployed interrogation unit that may be deployed on wireline or on coiled tubing. The Data Verification Tool may monitor one or more characteristics of the sensor including, without limitation, the electrical current drawn, the electrical voltage drop across the sensor, and/or the electrical impedance, including the spectrum (i.e., the frequency dependence of the impedance) of the sensor. Further, the Data Verification Tool may monitor the communication channel used to transmit the measured data from the sensor to the surface. For example, the Data Verification Tool may transmit information with voltage within a range, such as between 24 and 42 V, with a current between 8 and 12 mA. The Data Verification Tool evaluates the physical measurement process remotely based on diagnostics obtained during measurement. As part of the Data Verification Tool, a rule-based AI (applied logic) system may determine a course of action given a current state, (i.e., if a current state satisfies a condition, then take a specified action). Rule-based AI methods are often referred to as expert systems; decision trees with multiple “if-then” tests are an example of such a system. “If” the system is in a certain state, “then” a certain action is recommended. The state may be, e.g., “normal,” “casing leak,” “downhole fluid communication problem,” etc. In the case of a communication problem, the action may be “replace communication system hardware.” Such an applied logical method does not require training datasets or training, as other machine learning methods do (e.g., supervised learning). Applied logical methods analyze the data collected from this cable and, if necessary, trigger alarms. The analysis and logical methods operate regardless of the cable's design. Key health indicators may also be recorded in real time.

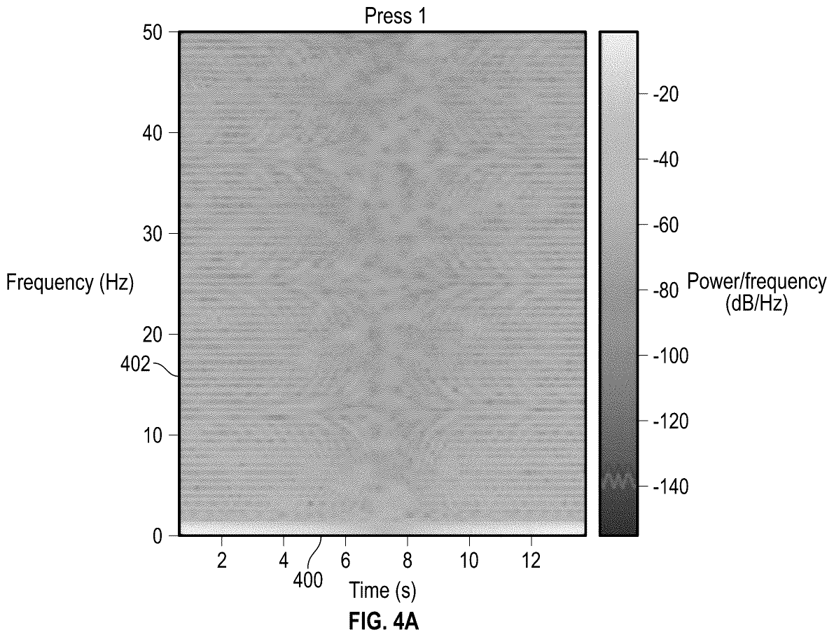

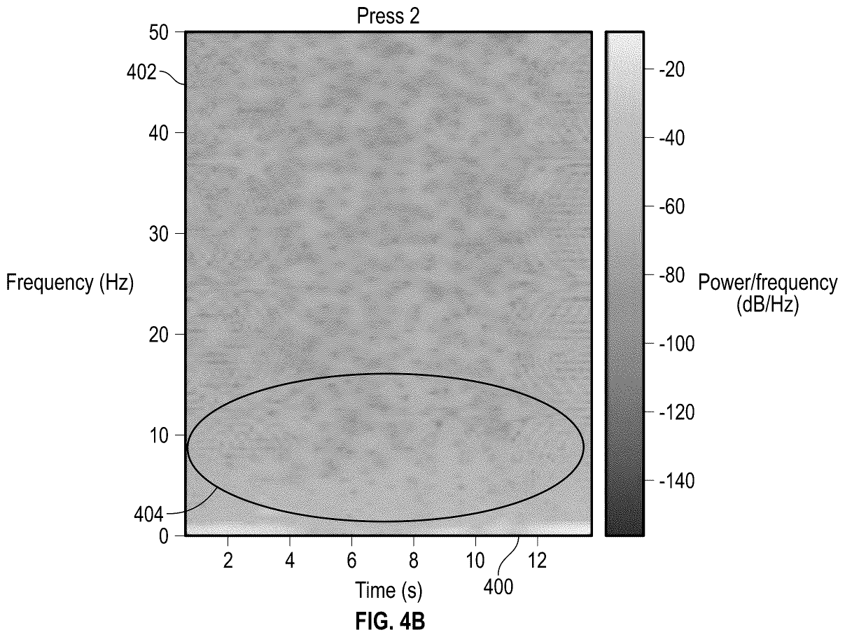

Next, in more detail, the Predictive Equipment Failure Tool (“PEFT”) may be used to detect and prevent equipment failure, depending on the type of error it detects. The PEFT may take data such as downhole pressure, downhole temperature, input voltage to the surface panel, current, or drilling depth per each gauge and use them to verify PDMASS performance. The PEFT may analyze the frequency spectrum and waveforms of raw and processed downhole data to detect temporal variations and disturbances in the performance of gauges. The PEFT may analyze raw data, such as recorded current or voltage, obtained from the pressure gauges. For example, frequency-time domain analysis tools may be applied to identify the signal abnormalities and/or deviations compared to signals from other gauges. FIGS. 4A and 4B show frequency-time spectrograms of the same measurements in FIGS. 2 and 3 (i.e., a working gauge and a failing gauge), respectively. Spectrograms are the result of transforming a one-dimensional temporal signal to a two-dimensional plot of time (400) versus frequency (402). This frequency-time domain analysis shows that the working pressure gauge shown in FIG. 4A has a spectrogram in the frequency-time domain clear without any disturbances, while the spectrogram related to the failing pressure gauge in FIG. 4B shows a distribution of frequencies in the high range corresponding to a chaotic disturbance (404) before failure.

The PEFT may help the operator in the field to perform a health check on the pressure gauges and anticipate any potential failure before it occurs, allowing for remedy or replacement. This operation may be performed manually by an operator and is in addition to the alarm-generating operation of the PEFT.

The PEFT may utilize one or more ML methods. The one or more ML methods are collectively designated the second ML model, to distinguish them from the first ML model used by the Data Validation Tool. The second ML model may utilize a plurality of inputs parameters to PDHMS and may be used to predict future equipment failure. For example, the second ML model may analyze the frequency spectrum of the energy in various PDHM logging data and utilize a wavelet analyzer of the waveform of PDHM raw data to identify the time variations to detect disturbances in the performance of the gauge. In some embodiments, the prediction of future sensor failure may include an estimation of the probability of sensor failure prior to a future time or date.

Following the Predictive Equipment Failure Tool, the Action Points Alarm System may generate alarms based on the observed data and predictions; the alarms may indicate problems in surface and/or downhole equipment—in particular, equipment malfunctions. The Action Points Alarm System identifies and contacts the proper organization based on the generated alarm according to predefined logical rules. For example, in the event of an equipment failure the Action Points Alaram System may contact a first appropriate response group to take the appropriate identified remedial actions, while in the even of a prediction of future equipment failure the Action Points Alaram System may contact a second appropriate response group to take the appropriate identified remedial actions. The logical rules triggered by the alarms may also be applied to other problems to produce recommended solutions. Table 1 shows a list of potential issues on the left-hand column, and the recommended action in the right-hand column.

TABLE 1
Potential issues and remedies

| Issue | Action recommender |
|---|---|
| Panel Unable to | Check the power from the source |
| power up | |
| No gauge | Check if the gauges powered up |
| readings | Check if the gauges are configured in the panel |
| | Check if the right current is delivered to the gauges |
| Open line | Check if the surface cable is connected the |
| message shown | electronic card properly |
| at the unit | Check the electrical measurement of the downhole |
| | Check if the surface cable is connected to the |
| | wellhead outlet connector |
| | Check the electrical measurement of the surface cable |
| Short circuit | Check if the surface cable is connected the electronic |
| message shown | card properly |
| at the unit | Check the electrical measurement of the downhole |
| | Check the surface cable is connected to the wellhead |
| | outlet connector and its integrity |
| | Check the electrical measurement of the surface cable |
| Cannot download | Check if the card connected properly to the panel |
| the data from | Check the communication between the PC and the card |
| Ifield card | |
| Cannot download | Check if the memory card is connected properly to the |
| the data from | panel |
| memory card | Check if the memory card is formatted properly |

Errors to Instrumentation (i.e., surface (107) or downhole), power, communication, or reliability may be classified as shown in Table 2. These are also listed by the Action Points Alarm System to pinpoint the cause of an alarm.

TABLE 2
Instrumentation errors

| Abbreviation | Description | Extended description |
|---|---|---|
| COMMN | Communication | Communication problem between |
| | Problem | wellhead outlet and database |
| INSTR | Instrument | Problems with surface instruments like |
| | Problem | panels, Remote Terminal Unit (RTU), |
| | | etc. |
| PWRFL | Power Failure | Power issues to panel, Supervisory |
| | | Control and Data Acquisition (SCADA) |
| UNRLB | Unreliable Data | Problems due to coefficients, registers |
| | | in panel. Issues of tag, SCADA, etc. |
| DHFAIL | Downhole Failure | Failure of equipment below wellhead |
| | | outlet resulting in no data or bad data |

The DPET element of the Data Validation Tool as well as the Predictive Equipment Failure Tool both make use of ML models. Hence, a review of a particular ML model that may be used in the PDMASS (108) is in order. Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and vision transformers. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength.

Commonly, in the literature, the selection of hyperparameters surrounding a machine-learned model is referred to as selecting the model “architecture.” Once a machine-learned model type and hyperparameters have been selected, the machine-learned model is trained to perform a task. Once trained, the performance of machine-learned models may be evaluated (e.g., using a partition of training data not seen during training known as a “hold-out set” or “validation set,” or sometimes a “test set”) and these machine-learned models are used in a production setting (also known as deployment of the machine-learned models), where the production setting indicates the use of the machine-learned models by the ML-based article checking system.

Many machine-learned model architectures described in the literature are based on neural networks. The neural network shown in FIG. 5 is presented only as an example ML method. At a high level, a neural network (500) may be graphically depicted as comprising nodes (502), shown here as circles, and edges (504), shown here as directed lines connecting the circles. The nodes (502) may be grouped to form layers, such as the four layers (508, 510, 512, 514) of nodes (502) shown in FIG. 5. The nodes (502) are grouped into columns for visualization of their organization. However, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be fully or sparsely connected. A neural network (500) will have at least two layers, with the first layer (508) considered as the “input layer” and the last layer (514) as the “output layer.” Any intermediate layer, such as layers (510) and (512) is usually described as a “hidden layer.” A neural network (500) may have zero or more hidden layers, e.g., hidden layers (510) and (512). However, a neural network (500) with at least one hidden layer (510, 212) may be described as a “deep” neural network forming the basis of a “deep learning model.” In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The numerical value of an edge, or even the edge (504) itself, is often referred to as a “weight” or a “parameter.” While training a neural network (500), numerical values are assigned to each edge (504). Additionally, every node (502) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) , \qquad ( 5 )$$

where i is an index that spans the set of “incoming” nodes (502) and edges (504) and ƒ is a user-defined function. Incoming nodes (502) are those that, when viewed as a graph (as in FIG. 5), have directed arrows that point to the node (502) where the numerical value is computed. Functional forms of ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed in the art. Each node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506) and are depicted in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training, the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Recall that a given data set will be composed of inputs and associated target(s), where the target(s) represent the “ground truth,” or the otherwise desired output. The neural network (500) output is compared to the associated input data target(s). The comparison of the neural network (500) output to the target(s) is typically performed by a so-called “loss function”; although other names for this comparison function such as “error function” and “cost function” are commonly employed. Many types of loss functions are available, such as the mean-squared-error function. However, the general characteristic of a loss function is that it provides a numerical evaluation of the similarity between the neural network (500) output and the associated target(s). The loss function may also be constructed to impose additional constraints on the values assumed by the edges (504), for example, by adding a penalty term, which may be physics-based, or a regularization term. Generally, the goal of a training procedure is to alter the edge (504) values to promote similarity between the neural network (500) output and associated target(s) over the data set. Thus, the loss function is used to guide changes made to the edge (504) values, typically through a process called “backpropagation.”

The loss function will usually not be reduced to zero during training. And, once trained, it is not necessary or required that the neural network (500) exactly reproduce the output elements in the training data set when operating upon the corresponding input elements. Indeed, a neural network (500) that exactly reproduces the output for its corresponding input may be perceived to be “fitting the noise.” In other words, it is often the case that there is noise in the training data, and a neural network (500) that is able to reproduce every detail in the output is reproducing noise rather than true signal. The price to pay for using such a “perfect” neural network (500) is that it will be limited to fitting only the training data and not able to generalize to produce a realistic output for a new and different input that has never been seen by it before.

For example, downhole pressure may be estimated, in the absence of validated downhole pressure data using a ML model trained with previously recorded training data including downhole temperature and surface flowrate, viscosity, and density data as input and previously recorded and validated downhole pressure data as output.

In another example, future equipment failure may be predicted using previously recorded training data, including electrical current, voltage and spectral impedance measurements from varying periods prior to known equipment failure events.

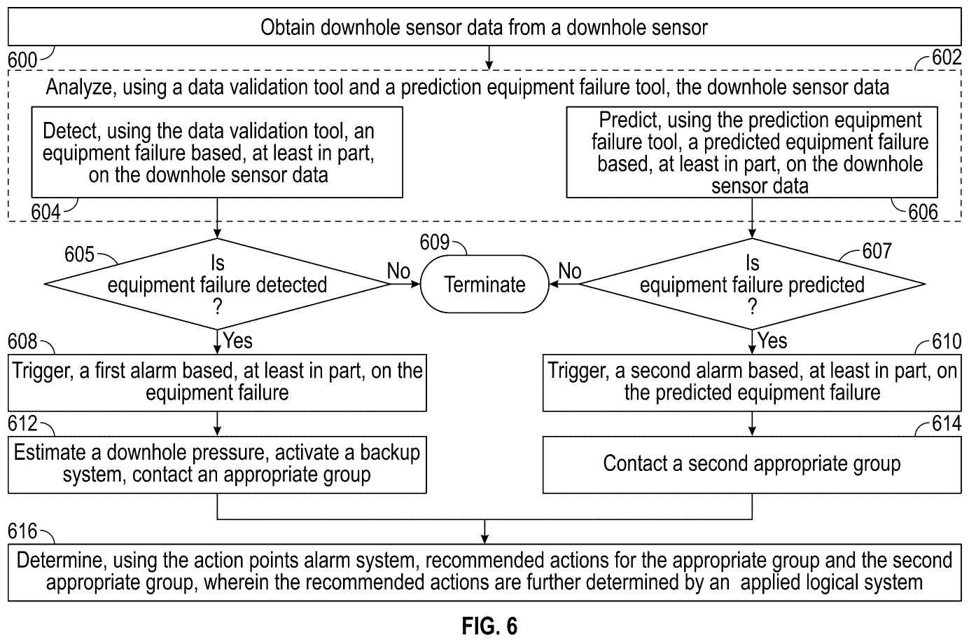

The general method for using the PDMASS (108) is outlined here as a workflow in FIG. 6. First, in Step 600, sensor data is obtained from a plurality of sensors of a well that includes a first downhole pressure sensor. The sensor may be a gauge or other kind of sensor. The data may be gauge pressure data, gauge temperature data, upstream wellhead pressure data, upstream wellhead temperature data, downstream wellhead pressure data, reservoir pressure data, choke valve position, ESP frequency data, ESP motor current data, friction loss data, gravity data, different Zone WC data, vertical distance data, bubble pressure data, static oil gradient data, input voltage to surface panel data, current data, and drilling depth per gauge data. However, this is not an exhaustive list, and other data types are permissible, including diagnostic data related to the sensor. Cables enable communication from the surface (107) to the sensors. However, other modes of communication are possible, as well, such as mud-pulse telemetry, radio waves, etc.

In Step 602, a first determination is made, using a first model of a data validation tool, as to whether the first downhole pressure sensor is faulty. This first model may be a machine learning model, although it could be another kind of model. This first model may be trained on historical datasets that contain examples of both faulty and functional sensor data.

In Step 604, upon determining that the first downhole pressure sensor is faulty, a second model of the data validation tool known as a downhole pressure estimation tool (DPET) determines a predicted pressure for the first downhole pressure sensor based on a subset of the sensor data. Upon determining that the first downhole pressure sensor is faulty, the DPET may predict downhole pressure data using a machine learning method after being trained on historical data. The data use for prediction and training may be any kind of data that can be recorded downhole. Multiple datasets may be simultaneously used for either the training or the prediction.

In Step 606, a second determination is made, using a data verification tool, of an operating state of the well based on the predicted pressure. I.e., after determining the downhole pressure using the DPET, a classification may be made of the state of equipment and the downhole environment.

In Step 608, a recommended action is transmitted based on the operating state. That is, the determined state, including the health, of the equipment or downhole environment will lead, through an applied logical system, to a recommended action that should be taken. For example, if the state of the downhole environment is a casing leak, the recommended action may be to repair the downhole casing. The triggering of an alarm may occur for a particular operating state. Among possible equipment failure scenarios, the triggering of an alarm may be indicative of a leak in a casing. Other triggering events may include, without limitation, the cessation of the reception of data from downhole, the loss of power provided to either surface or downhole units, erratic or the cessation of measurements from one or more downhole or surface sensors.

The methods described above also allow for other operations in addition to those in Steps 600-608. For instance, prediction future equipment failure may be performed by the PEFT. The PEFT may analyze a time-frequency spectrogram, a frequency spectrum, and waveforms. The prediction of equipment failure may result when a calculated mean frequency of a currently observed waveform is greater than a historical mean frequency. However, other criteria may be used to predict equipment failure, such as, e.g., an increase in root mean square energy. The prediction of equipment failure may also result through the application of an ML method. An alarm may be triggered based on the determination of a pre-failure state.

The Action Points Alarm System is used to recommend actions based on a pre-failure state, wherein the recommended actions are further determined by an applied logical system. The applied logical system may determine a health of surface equipment and a health of downhole equipment. The Action Points Alarm System may specify a problem such as “panel unable to power up,” “no gauge readings,” “cannot download the data from memory card,” etc. The recommended actions for these, respectively, may be (but is not limited to) “Check the power from the source,” “Check if the gauges powered up,” and “Check if the memory card is connected properly to the panel.”

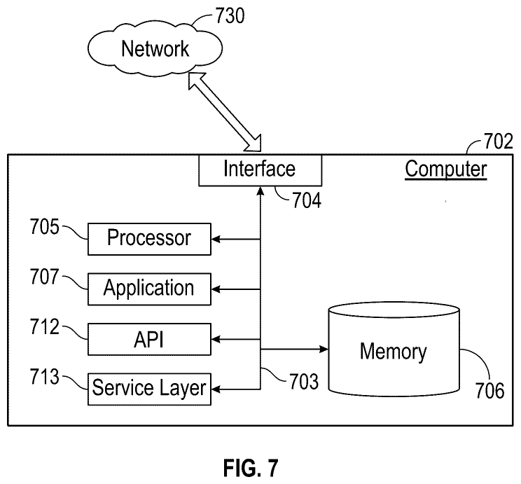

The PDMASS (108) is a particular example of a computer system. FIG. 7 depicts a block diagram of a such a computer system used to provide computational functionalities associated with described algorithms, methods, functions, processes, flows, and procedures as described in this disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. The illustrated computer (702) may also encompass custom-designed neural networks (500), as well as graphics processing units (GPUs). Additionally, the computer (702) may include an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730). In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over a network (730) from a client application (for example, executing on another computer (702)) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713)). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, the application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computers (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining sensor data from a plurality of sensors disposed in a well;
using a data validation tool:
determining, using a first model of the data validation tool, a presence of a faulty sensor in the plurality of sensors based, at least in part, on the sensor data,
determining, with a second model of the data validation tool, a predicted value of the faulty sensor based, at least in part, on a subset of the sensor data, and
determining an operating state of the well based, at least in part, on the predicted value; and
transmitting, using a data verification tool, a recommended action based on the operating state.

2. The method of claim 1, wherein:
the faulty sensor comprises a faulty pressure sensor; and
the second model comprises a downhole pressure estimation tool.

3. The method of claim 1, wherein transmitting the recommended action comprises, using an Action Points Alarm System:
determining recommended actions and a first appropriate response group, and
contacting the first appropriate response group.

4. The method of claim 1, wherein the first model of the data validation tool comprises a first trained machine learning model, previously trained using historical sensor data from the plurality of sensors, to predict a value of the faulty sensor from a subset of the plurality of sensors.

5. The method of claim 4, wherein the subset of the plurality of sensors excludes the faulty sensor.

6. The method of claim 1, wherein:
the second model comprises a second trained machine learning model; and
training the second trained machine learning model comprises, upon determining the presence of the faulty sensor:
obtaining historical sensor data from plurality of sensors disposed in a well, wherein historical sensor data relates to a time-period prior to determination of the presence of the faulty sensor,
determining, with a verification tool, a subset of sensors with a current positive health status,
forming a historical subset from subset of sensors with the current positive health status, and
training the second trained machine learning model using the historical subset;
wherein the second trained machine learning model is configured to receive, as input, current data from the subset of sensors with positive health status and return, as output, the predicted value for the faulty sensor.

7. A method, comprising:
obtaining sensor data from a plurality of sensors disposed in a well;
predicting, using a predictive equipment failure tool, a predicted future sensor failure for at least one sensor of the plurality of sensors based, at least in part, on the sensor data; and
transmitting, using a data verification tool, a recommended action based on the predicted future sensor failure.

8. The method of claim 7, wherein predicting the predicted future sensor failure comprises determining a probability of sensor failure prior to a future time.

9. The method of claim 7, wherein the predictive equipment failure tool comprises a trained machine learning model.

10. The method of claim 7, wherein transmitting a recommended action comprises:
determining, using the data verification tool, a cause of the predicted future sensor failure; and
using an action points alarm system:
determining a second appropriate response group;
determining recommended actions for a second appropriate group, and
contacting the second appropriate group.

11. The method of claim 7, wherein prediction of the predicted future sensor failure is based, at least in part, on analyzing a time-frequency spectrogram.

12. The method of claim 11, wherein analyzing the time-frequency spectrogram comprises:
calculating a mean frequency of a frequency spectrum; and
determining the mean frequency is greater than a historical mean frequency.

13. A system, comprising:
a plurality of sensors disposed in a well, configured to obtain sensor data;
a data validation tool, configured to:
determine, using a first model of the data validation tool, a presence of a faulty sensor in the plurality of sensors based, at least in part, on the sensor data,
determine, with a second model of the data validation tool, a predicted value of the faulty sensor based, at least in part, on a subset of the sensor data, and
determine an operating state of the well based, at least in part, on the predicted value; and
a data verification tool, configure to transmit a recommended action based on the operating state.

14. The system of claim 13, further comprising:
a predictive equipment failure tool, configured to predict a predicted future sensor failure for at least one sensor of the plurality of sensors based, at least in part, on the sensor data;
and the data verification tool, further configured to recommended action based on the predicted future sensor failure.

15. The system of claim 13, wherein: wherein:
the faulty sensor comprises a faulty pressure sensor; and
the second model comprises a downhole pressure estimation tool.

16. The system of claim 13, wherein the first model of the data validation tool is a trained machine learning model, previously trained using historical sensor data from a plurality of sensors.

17. The system of claim 13, wherein the data verification tool comprises an Action Points Alarm System, configured to:
determine recommended actions and a first appropriate response group, and
contact the first appropriate response group.

18. The system of claim 13, wherein the first model of the data validation tool is a trained machine learning model, previously trained using historical sensor data from a plurality of sensors.

19. The system of claim 14, wherein prediction of a predicted future sensor failure is based, at least in part, on analyzing a time-frequency spectrogram.

20. The system of claim 13, wherein the second model comprises a machine learning model configured, upon determination of the presence of a faulty sensor, to be trained, wherein the training comprises:
obtaining historical sensor data from plurality of sensors disposed in a well, wherein historical sensor data relates to a time-period prior to determination of the presence of the faulty sensor,
determining, with a verification tool, a subset of sensors with a current positive health status,
forming a historical subset from subset of sensors with the current positive health status, and
training the second trained machine learning model using the historical subset;
wherein the second trained machine learning model is configured to receive, as input, current data from the subset of sensors with positive health status and return, as output, the predicted value for the faulty sensor.
